(19) United States
(12) Patent Application Publication
(10) Pub. No.: US 2017/0122028 A1
(43) Pub. Date: May 4, 2017

(54) LIGHT CONTROL ELEMENT AND BUILDING MATERIAL PROVIDED WITH SAME

(71) Applicant: PANASONIC INTELLECTUAL PROPERTY MANAGEMENT CO., LTD., Osaka (JP)

(72) Inventors: Yuko SUZUKA, Osaka (JP); Yoshikazu KUZUOKA, Osaka (JP)

(73) Assignee: PANASONIC INTELLECTUAL PROPERTY MANAGEMENT CO., LTD., Osaka (JP)

(21) Appl. No.: 15/318,471

(22) PCT Filed: Jun. 24, 2015
(86) PCT No.: PCT/JP2015/003153

§ 371 Date: Dec. 13, 2016

(30) Foreign Application Priority Data
Jul. 23, 2014 (JP) 2014-150028

(51) Int. Cl. E06B 9/24; G02F 1/1334; G02F 1/1343; E06B 3/67; G02F 1/137

(52) U.S. Cl. CPC E06B 9/24; E06B 3/67; G02F 1/137; G02F 1/134309; G02F 1/1334; E06B 2009/2417; E06B 2009/2464; G02F 2001/13756

(57) ABSTRACT

A light control element includes a first substrate, a light control laminate, and a second substrate opposite to the first substrate. The light control laminate includes: a first electrode disposed on the first substrate; a second electrode opposite to the first electrode; and a light control layer disposed between the first electrode and the second electrode and formed to change in the optical state according to power supplied using the first electrode and the second electrode. The light control element further includes: a third electrode formed on the second substrate and opposite to the second electrode; and a liquid crystal layer disposed between the second electrode and the third electrode. The light control laminate is sealed by the liquid crystal layer and the first substrate.

### TECHNICAL FIELD

The present invention relates to a light control element and a building material provided with the same. More specifically, the present invention relates to a light control element provided with a liquid crystal and to a building material.

### BACKGROUND ART

In recent years, light control elements called smart glasses have been applied to buildings and car windows. For example, a light control window material (light control element) disclosed in Patent Literature (PTL) 1 is provided with a liquid-crystal containing layer. The liquid-crystal containing layer is formed to change in the orientation state of the liquid crystal contained in the liquid-crystal containing layer according to the applied voltage. With the change in the orientation state of the liquid crystal, the light transmissivity of the liquid-crystal containing layer changes. More specifically, the light transmissivity of the light control window material changes.

### CITATION LIST

### Patent Literature

PTL 1: Japanese Unexamined Patent Application Publication No. 2010-208861

### SUMMARY OF THE INVENTION

### Problem that Invention is to Solve

Here, in some cases, a light control element may be provided with a functional layer in addition to a liquid-crystal containing layer. The light control window material disclosed in PTL 1 is provided with an infrared reflective layer in addition to the liquid-crystal containing layer. However when the functional layer is prone to deterioration from, for example, moisture, the life span of the light control element may be shortened.

The present invention was conceived in view of the stated problem, and has an object to provide a light control element that has excellent optical characteristics and a long life span.

### Solution to Problem

A light control element according to an aspect of the present invention includes, a first substrate, a light control laminate, and a second substrate disposed opposite to the first substrate. The light control laminate includes: a first electrode disposed on the first substrate; a second electrode disposed opposite to the first electrode; and a light control layer disposed between the first electrode and the second electrode, the first electrode, the second electrode, and the light control layer being arranged in a thickness direction of the first substrate. The light control layer is formed to change in an optical state according to power supplied using the first electrode and the second electrode. The light control element further includes: a third electrode formed on the second substrate to be opposite to the second electrode; and a liquid crystal layer disposed between the second electrode and the third electrode. The light control laminate is sealed by the liquid crystal layer and the first substrate.

### Advantageous Effect of Invention

With the present invention, a light control element that has excellent optical characteristics and a long life span can be obtained.

### BRIEF DESCRIPTION OF DRAWINGS

FIG. 1 is a cross-sectional view showing a light control element according to Embodiment 1.

FIG. 2 is a cross-sectional view showing a first variation of the light control element according to Embodiment 1.

FIG. 3 is a cross-sectional view showing a second variation of the light control element according to Embodiment 1.

FIG. 4 is a cross-sectional view showing a third variation of the light control element according to Embodiment 1.

FIG. 5 is a cross-sectional view showing a light control element according to Embodiment 2.

FIG. 6 is a perspective view showing a building material including the light control element according to Embodiment 1 or 2.

### DESCRIPTION OF EXEMPLARY EMBODIMENTS

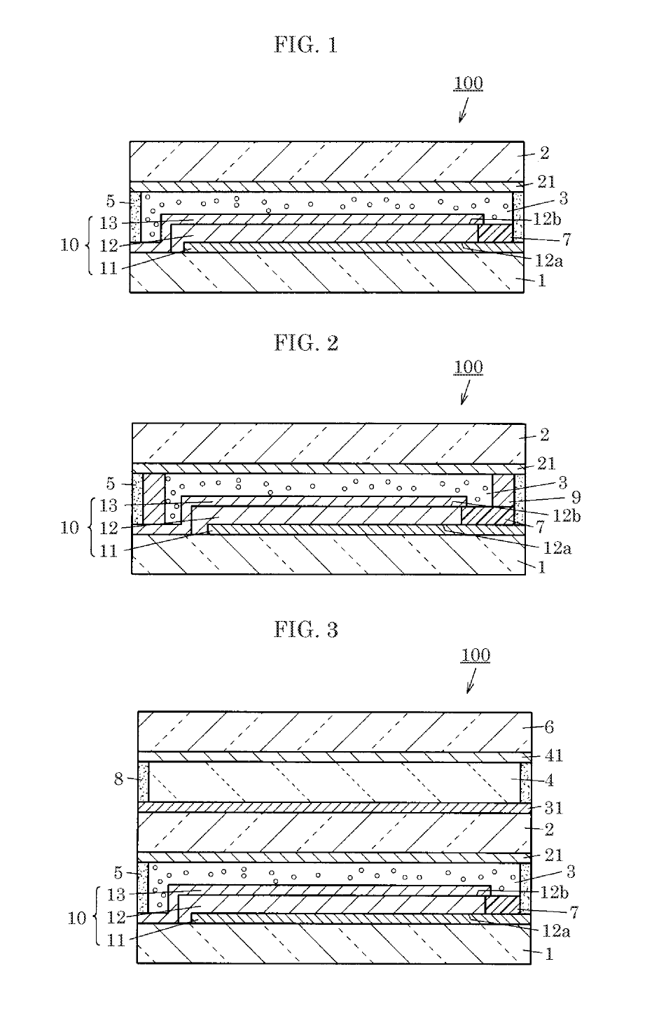

FIG. 1 is a cross-sectional view showing light control element 100 according to Embodiment 1. As shown in FIG. 1, light control element 100 includes first substrate 1, light control laminate 10 formed on first substrate 1, and second substrate 2 disposed opposite to first substrate 1. Light control laminate 10 includes first electrode 11 disposed on first substrate 1, second electrode 13 disposed opposite to first electrode 11, and light control layer 12 disposed between first electrode 11 and second electrode 13. Light control element 100 further includes the following: third electrode 21 that is formed on second substrate 2 to be opposite to second electrode 13; and liquid crystal layer (hereinafter, also referred to as first liquid crystal layer) 3 that is disposed between second electrode 13 and third electrode 21 and seals light control laminate 10.

Each of first substrate 1 and second substrate 2 has transparency. More specifically, each of first substrate 1 and second substrate 2 has transparency to visible light. In Embodiment 1, the wavelength of visible light ranges from 400 nm to 750 nm. As an example, each of first substrate 1 and second substrate 2 can be formed with glass or resin.

Assume that each of first substrate 1 and second substrate 2 is formed with glass. In this case, since moisture permeability of glass is low, external moisture can be inhibited from reaching light control layer 12 via first substrate 1 and second substrate 2. On this account, when light control layer 12 is prone to deterioration from moisture (for example, when light control layer 12 is formed with an organic material), the life span of light control layer 12 can be increased by forming first substrate 1 and second substrate 2 with glass. Thus, the life span of light control element 100 can be increased. Moreover, glass can have an ultraviolet absorption property. Thus, forming first substrate 1 and second substrate 2 with glass can inhibit light control layer 12 from deteriorating. Examples of glass include soda glass, alkali-free glass, and high refractive index glass. First substrate 1 and second substrate 2 may be thin films formed with glass. In this case, light control element 100 that has high transparency and high moisture-proof property and is flexible can be obtained.

Furthermore, assume that each of first substrate 1 and second substrate 2 is formed with resin, which is less prone to rupture. In this case, even when first substrate 1 and second substrate 2 are ruptured, the ruptured pieces of first substrate 1 and second substrate 2 are inhibited from dispersing. Thus, light control element 100 that is safer can be obtained. Moreover, when first substrate 1 and second substrate 2 are formed with resin, light control element 100 that is flexible can be obtained. First substrate 1 and second substrate 2 formed with resin may be films. Examples of resin include PET (polyethylene terephthalate) and PEN (polyethylene naphthalate).

Here, although each of first substrate 1 and second substrate 2 according to Embodiment 1 has a flat surface, each of first substrate 1 and second substrate 2 may have a curved surface. Each of first substrate 1 and second substrate 2 may have only a flat surface or curved surface. The curved surface may be arc-shaped in cross section. Each of first substrate 1 and second substrate 2 may have both a flat surface and a curved surface.

Each of the surface of first substrate 1 and the surface of second substrate 2 may be coated with at least one of ultraviolet reflective material, ultraviolet absorbing material, and dampproof material. In this case, the life span of light control element 100 can be increased. Moreover, each of the surface of first substrate 1 and the surface of second substrate 2 may be coated with antifouling material. In this case, the substrate surfaces can be protected from adhesion of contamination. As a result, decrease in light transmissivity can be reduced and cleaning burden can also be reduced.

In Embodiment 1, each of first substrate 1 and second substrate 2 is formed with flat plate glass. It should be noted that first substrate 1 and second substrate 2 according to Embodiment 1 are bonded together by adhesive portion 5 described later.

Light control laminate 10 is disposed on first substrate 1, and is a laminate of first electrode 11, light control layer 12, and second electrode 13. Light control laminate 10 is disposed between first substrate 1 and second substrate 2. First electrode 11, light control layer 12, and second electrode 13 are arranged along the thickness direction of first substrate 1, in this order from a side closer to first substrate 1.

Each of first electrode 11 and second electrode 13 has electrical conductivity. Moreover, each of first electrode 11 and second electrode 13 has transparency to visible light. Each of first electrode 11 and second electrode 13 can be formed with transparent metal oxide (such as ITO (indium tin oxide) or IZO (indium zinc oxide)) or resin containing conducting particles and thin metal wires. Moreover, each of first electrode 11 and second electrode 13 may be a thin film formed with silver, or may be a laminate of transparent metal oxide and metal. First electrode 11 and second electrode 13 may be formed with mutually different materials or with the same material.

Each of first electrode 11 and second electrode 13 according to Embodiment 1 has an extension portion that extends from light control laminate 10 toward an end portion of first substrate 1. The extension portion is formed to be connected to an external power source. More specifically, the extension portion penetrates adhesive portion 5 and is exposed at the end portion of first substrate 1 so as to supply power from the external power source to light control element 100. The extension portion of first electrode 11 is a portion that is not covered by light control layer 12 out of first electrode 11. The extension portion of second electrode 13 is a portion that is not overlaid (covered) with light control layer 12 formed on first substrate 1 out of second electrode 13. The extension portions of first electrode 11 and second electrode 13 function as terminals for supplying power to light control layer 12. Note that the extension portion of second electrode 13 also functions as a terminal for supplying power (voltage) to liquid crystal layer 3.

Light control layer 12 is disposed between first electrode 11 and second electrode 13. Light control layer 12 is formed to change in the optical state of light control layer 12 according to power supplied to light control layer 12 using first electrode 11 and second electrode 13. It should be noted that the optical state discussed in the present description refers to one of the states of light emission, light scattering, light reflection, and light absorption. Although the optical state may relate to visible light, the optical state may also relate to infrared light or ultraviolet light. When the optical state of light control layer 12 changes according to the supplied power, this means that the state of light emitted from the surface of light control layer 12 is adjusted. The state of light refers to, for example, a direction of light travel. Alternatively, when the optical state of light control layer 12 changes according to the supplied power, this means that the amount of light emitted from the surface of light control layer 12 is adjusted.

For example, assume that light control layer 12 changes in light scattering or light reflection according to the supplied power. In this case, the direction of light emitted from the surface of light control layer 12 changes when light control element 100 (light control layer 12) receives light externally. In other words, the state of light emitted from the surface of light control layer 12 changes. Alternatively, assume that light control layer 12 changes in light absorption according to the supplied power. In this case, when light control element 100 (light control layer 12) receives light externally, the amount of light emitted from the surface (light receiving surface) of light control layer 12 receiving the light that passes through light control layer 12 and from the opposite surface (light emitting surface) of light control layer 12 changes. In other words, the amount of light emitted from the surface of light control layer 12 according to the supplied power is adjusted. It should be noted that the surface where the state or amount of light to be emitted is adjusted may be the surface opposite to the light receiving surface. Moreover, the surface where the amount of light to be emitted is adjusted may be both the light receiving surface and the surface opposite to the light receiving surface.

To be more specific, assume that light control layer 12 (light control element 100) receives light that travels in the direction from first substrate 1 toward second substrate 2. Or more specifically, assume that the light receiving surface is surface 12a of light control layer 12 and located opposite to first substrate 1. In this case, the state or amount of light passing through light control layer 12 and emitted from surface 12b (light emitting surface) is adjusted. Thus, the state or amount of light emitted from second substrate 2 is adjusted. More specifically, when light control element 100 receives light on first substrate 1, the state or amount of light emitted from second substrate 2 can be adjusted by adjusting the power supplied to light control layer 12. Alternatively, assume that light control layer 12 (light control element 100) receives light that travels in the direction from second substrate 2 toward first substrate 1. Or more specifically, assume that the light receiving surface is surface 12b of light control layer 12 and located opposite to second substrate 2. In this case, the state or amount of light passing through light control layer 12 and emitted from surface 12a is adjusted. Thus, when light control element 100 receives light on second substrate 2, the state or amount of light emitted from first substrate 1 can be adjusted by adjusting the power supplied to light control layer 12. It should be noted that light control layer 12 can receive both the light traveling in the direction from first substrate 1 toward second substrate 2 and the light traveling in the direction from second substrate 2 toward first substrate 1. Furthermore, multi-level adjustment is preferable for the state or amount of light to be emitted from light control layer 12.

Light control layer 21 may include a liquid crystal and be formed to change in light scattering or light reflection according to the supplied power (voltage). More specifically, light control layer 12 may be a liquid crystal layer (hereinafter, also referred to as a second liquid crystal layer) including a liquid crystal. When the orientation (orientation state) of the liquid crystal changes, light control layer (second liquid crystal layer) 12 changes in light scattering and light reflection.

Light control layer 12 may contain at least one of a nematic liquid crystal, a cholesteric liquid crystal, and a ferroelectric liquid crystal, for example. Light control layer 12 may be a polymer-dispersed liquid crystal layer containing a polymer-dispersed liquid crystal. A polymer-dispersed liquid crystal layer can change between a transparent state and a light scattering state according to an applied voltage. Moreover, light control layer 12 may be a cholesteric liquid crystal layer containing a cholesteric liquid crystal. A cholesteric liquid crystal layer can change among a transparent state, a light scattering state, and a light reflection state according to an applied voltage. The polymer-dispersed liquid crystal, cholesteric liquid crystal, transparent state, light scattering state, and light reflection state are described later. It is preferable that light control layer 12 may maintain the light scattering state obtained at the time of voltage application. With this, the power efficiency of light control element 100 can be enhanced. The property of maintaining the light scattering state is called hysteresis. A period of time during which the light scattering state is maintained may be longer, or more specifically, one hour or longer, for example.

Alternatively, light control layer 12 may be formed to change in light absorption according to the supplied power (current). More specifically, light control layer 12 may be a light absorbing layer that changes in light absorption according to the supplied current. The light absorbing layer may be formed to change in light absorption for at least one of visible light, ultraviolet light, and infrared light according to the supplied current. The light absorbing layer may be formed to change in light absorption only for light of a specific wavelength in one of a visible light region, an ultraviolet light region, and an infrared light region, according to the supplied current.

For example, the light absorbing layer may be formed to allow light to pass through the layer (that is, the light absorbing layer decreases in light absorption and is transparent) when supplied with a current. At the same time, the light absorbing layer may be formed to absorb light (that is, the light absorbing layer increases in light absorption) when supplied with no current. Alternatively, the light absorbing layer may be formed to allow light to pass through the layer (that is, the light absorbing layer decreases in light absorption and is transparent) when supplied with no current. At the same time, the light absorbing layer may be formed to absorb light (that is, the light absorbing layer increases in light absorption) when supplied with a current. Furthermore, the light absorbing layer may be formed to change into a state to allow light to pass through the layer when supplied with a current and then change into a state to absorb light when supplied with a reverse current. In this case, the light absorbing layer may be formed to maintain the corresponding one of these states while no current is supplied. The light absorbing layer can be formed using, for example, a material containing tungsten oxide in addition to the liquid crystal.

Alternatively, light control layer 12 may be formed to emit light (visible light, for example) according to the supplied power (current). More specifically, the light control layer 12 may be a light emitting layer that emits light according to the supplied current. Assume that light control layer 12 is a light emitting layer. In this case, when light control layer (light emitting layer) 12 is supplied with a current, light control layer 12 emits light and the amount of light emitted from the surface of light control layer 12 increases. Moreover, when the current supply to light control layer 12 is interrupted, light control layer 12 stops emitting light and the amount of light emitted from the surface of light control layer 12 thus decreases. In this way, the amount of light emitted from the surface of light control layer (light emitting layer) 12 that is formed to emit light is adjusted. As described, when light control layer 12 is a light emitting layer, the amount of light emitted from light control element 100 can be adjusted even when light control element 100 receives no light externally.

The light emitting layer that functions as light control layer 12 contains an appropriate light emitting material. The light emitting layer may include, in addition to the layer containing the light emitting material, one or more layers appropriately selected from among, for example, a hole injection layer, a hole transport layer, an electron transport layer, an electron injection layer, and an intermediate layer. When the light emitting layer contains an organic light-emitting material, light control laminate 10 may also be referred to as an organic electroluminescent element. It should be noted that the light emitting layer has transparency to visible light.

To summarize the above explanation, light control layer 12 may be one of the second liquid crystal layer, the light absorbing layer, and the light emitting layer. The second liquid crystal layer may be a polymer-dispersed liquid crystal layer or a cholesteric liquid crystal layer.

Third electrode 21 has electrical conductivity. Moreover, third electrode 21 has transparency to visible light. Third electrode 21 may be formed with the same material used for forming first electrode 11 and/or second electrode 13, or with a different material. Third electrode 21 is disposed on the opposite side of first electrode 11 and second electrode 13 at a spacing from second electrode 13 by the interposition of liquid crystal layer 3. In Embodiment 1, third electrode 21 is formed on one whole surface of second substrate 2. Moreover, an end portion of third electrode 21 is exposed at an end portion of second substrate 2 so as to be connected to the external power source. An extension portion of third electrode 21 functions as a terminal for applying a voltage to liquid crystal layer 3, together with the extension portion of second electrode 13.

In Embodiment 1, light control element 100 includes adhesive portion 5 that bonds first substrate 1 and second substrate 2 together. Adhesive portion 5 is disposed to surround light control laminate 10. In Embodiment 1, adhesive portion 5 is formed in the shape of a frame for surrounding light control laminate 10. Adhesive portion 5 also functions as a spacer maintaining a distance between first substrate 1 and second substrate 2 so that second electrode 13 and third electrode 21 are separated by liquid crystal layer 3. Adhesive portion 5 can be formed with a resin having an adhesive property. Adhesive portion 5 may be formed with a thermosetting resin or an ultraviolet curable resin. Moreover, adhesive portion 5 may contain a spacer material, such as particles. In Embodiment 1, adhesive portion 5 has an electrical insulation property. Adhesive portion 5 may or may not have transparency to visible light. Note that although light control element 100 according to Embodiment 1 includes adhesive portion 5, light control element 100 may not include adhesive portion 5.

Liquid crystal layer 3 is disposed between second electrode 13 and third electrode 21 and contains a liquid crystal. Liquid crystal layer 3 is formed so that the liquid crystal contained in liquid crystal layer 3 changes in the orientation (orientation state) according to the voltage applied to liquid crystal layer 3, that is, the voltage applied between second electrode 13 and third electrode 21. More specifically, liquid crystal layer 3 is formed to change in the optical state (the light scattering or light reflection state) according to the applied voltage. Thus, liquid crystal layer 3 is formed so that the state or amount of light emitted from the surface of liquid crystal layer 3 is adjusted according to the applied voltage. Furthermore, multi-level adjustment is preferable for the state or amount of light to be emitted from liquid crystal layer 3.

Liquid crystal layer 3 can change between two or more states selected from among a transparent state, a light scattering state, and a light reflection state, according to the applied voltage. Here, the transparent state refers to a state in which the layer has transparency to light. For example, the light transmissivity of the layer in the transparent state may be 85% or more, or 90% or more. Moreover, the light transmissivity of the layer in the transparent state may be 100% or less. In Embodiment 1, liquid crystal layer 3 in the transparent state is transparent to visible light. The light scattering state refers to a state in which light is scattered. Haze that represents the light scattering rate of the layer in the light scattering state varies depending on the applied voltage, and may be, for example, 85% or more, or 90% or more. Moreover, haze that represents the light scattering rate of the layer in the light scattering state may be 100% or less. In Embodiment 1, liquid crystal layer 3 in the light scattering state scatters visible light. Thus, liquid crystal layer 3 in the light scattering state is in the same state as opaque glass. The light reflection state refers to a state in which light is reflected. The light reflectivity of the layer in the light reflection state varies depending on the applied voltage, and may be, for example, 80% or more, or 90% or more. Moreover, the light reflectivity of the layer in the light reflection state may be 100% or less. In Embodiment 1, liquid crystal layer 3 in the light reflection state reflects visible light. Note that liquid crystal layer 3 can be in a different state other than the transparent state, the light scattering state, and the light reflection state, according to the applied voltage.

Liquid crystal layer 3 may be formed to change between the transparent state and the light scattering state. Assume that liquid crystal layer 3 is a polymer-dispersed liquid crystal layer containing a polymer-dispersed liquid crystal. In this case, by control of the voltage applied to liquid crystal layer 3, that is, by electric-field control, liquid crystal layer 3 can change between the transparent state and the light scattering state. In other words, liquid crystal layer 3 may contain a polymer-dispersed liquid crystal.

A polymer-dispersed liquid crystal refers to a droplet (particle) of liquid crystal dispersed in a polymer. More specifically, when liquid crystal layer 3 contains a polymer-dispersed liquid crystal, this means that liquid crystal layer 3 contains liquid droplets dispersed throughout the polymer. The polymer may allow light to pass through it. In Embodiment, the polymer allows light to pass through it and has transparency to visible light. The polymer may be a thermosetting polymer or an ultraviolet curable polymer. The liquid crystal of the polymer-dispersed liquid crystal layer may be a nematic liquid crystal. The liquid crystal droplets in the polymer-dispersed liquid crystal layer may be dispersed throughout the polymer in a pattern of dots. Moreover, the liquid crystals may be irregularly connected to each other in a netlike appearance in the polymer-dispersed liquid crystal layer.

Alternatively, liquid crystal layer 3 may be formed to change between the transparent state and the light reflection state. Assume that liquid crystal layer 3 is a cholesteric liquid crystal layer containing a cholesteric liquid crystal. In this case, by control of the voltage applied to liquid crystal layer 3, that is, by electric-field control, liquid crystal layer 3 can change between the transparent state and the light reflection state. In other words, liquid crystal layer 3 may contain a cholesteric liquid crystal (CLC). A cholesteric liquid crystal is a nematic liquid crystal having a helical structure, or more specifically, is a chiral nematic liquid crystal. The cholesteric liquid crystal has a plurality of layers in each of which rod-like molecules are aligned along an array direction. The plurality of layers are stacked in the thickness direction (in the present embodiment, the thickness direction of first substrate 1, that is, the vertical direction in FIG. 1) so that the array direction is helical.

When no voltage is applied to liquid crystal layer 3 containing the cholesteric liquid crystal, the cholesteric liquid crystal is brought into planar alignment and thus liquid crystal layer 3 achieves the light reflection state. Moreover, when a voltage is applied so that the cholesteric liquid crystal in liquid crystal layer 3 is brought into homeotropic alignment, liquid crystal layer 3 can achieve the transparent state. As described, in light control element 100 according to Embodiment 1, when liquid crystal layer 3 contains the cholesteric liquid crystal, the electric-field control allows the state of liquid crystal layer 3 to be switched between the transparent state and the light reflection state. Furthermore, when a voltage is applied so that the cholesteric liquid crystal in liquid crystal layer 3 is brought into focal conic alignment, liquid crystal layer 3 can achieve the light scattering state. With this, the electric-field control allows the state of liquid crystal layer 3 to be switched among the transparent state, the light scattering state, and the light reflection state.

It should be noted that, in light control element 100 according to Embodiment 1, each of first substrate 1, second substrate 2, first electrode 11, second electrode 12, and third electrode 21 has transparency to visible light. On this account, when both light control layer 12 and liquid crystal layer 3 are in the transparent state, light control element 100 allows light to pass through it and has transparency to visible light.

Liquid crystal layer 3 according to Embodiment 1 changes in the optical state according to the applied voltage. Moreover, liquid crystal layer 3 seals light control laminate 10. In other words, liquid crystal layer 3 covers light control laminate 10 above first substrate 1. In Embodiment 1, liquid crystal layer 3 fills a space enclosed by first substrate 1, second substrate 2, and adhesive portion 5. Here, a liquid crystal has a moisture-proof property. Thus, sealing light control laminate 10 by liquid crystal layer 3 containing the liquid crystal can suppress deterioration of light control layer 12 and increase the life span of light control element 100 even when light control layer 12 is prone to deterioration from moisture.

To summarize the above explanation, examples of light control element 100 according to Embodiment 1 include light control elements 100 according to first to fifth examples described below.

Light control element 100 according to the first example includes liquid crystal layer 3 that can be in the light scattering state and a light emitting layer that functions as light control layer 12. More specifically, light control element 100 according to the first example includes the light emitting layer and liquid crystal layer 3 containing a polymer-dispersed liquid crystal. Alternatively, light control element 100 according to the first example includes the light emitting layer and liquid crystal layer 3 containing a cholesteric liquid crystal. In the first example, by control of a voltage applied to liquid crystal layer 3 and a current supplied to the light emitting layer, light can be emitted from the light emitting layer and the light emitted from the light emitting layer can be scattered in liquid crystal layer 3. Thus, light control element 100 that emits light having a small angle dependence can be obtained. Moreover, even when the light emitting layer contains, for example, an organic light-emitting material and thus is prone to deterioration from moisture, deterioration of the light emitting layer can be suppressed and the life span of light control element 100 can be increased since liquid crystal layer 3 seals light control laminate 10.

Light control element 100 according to the second example includes liquid crystal layer 3 that can be in the light reflection state and a light emitting layer that functions as light control layer 12. More specifically, light control element 100 according to the second example includes the light emitting layer and liquid crystal layer 3 containing a cholesteric liquid crystal. In the second example, by control of a current supplied to the light emitting layer and a voltage applied to liquid crystal layer 3, light can be emitted from the light emitting layer and the light emitted from the light emitting layer can be reflected by liquid crystal layer 3. Thus, the light from the light emitting layer can be efficiently emitted in one direction (toward first substrate 1). Moreover, the liquid crystal layer containing the cholesteric liquid crystal can be in the light scattering state. On this account, by control of a voltage applied to liquid crystal layer 3 and a current supplied to the light emitting layer, light can be emitted from the light emitting layer and the light emitted from the light emitting layer can be scattered in the liquid crystal layer 3. Furthermore, even when the light emitting layer is prone to deterioration from moisture, deterioration of the light emitting layer can be suppressed and the life span of light control element 100 can be increased since liquid crystal layer 3 seals light control laminate 10.

When light control element 100 includes the light emitting layer as in the first and second examples, light control element 100 can produce and emit light on its own. Light control element 100 including the light emitting layer as described can be called an active light control element. The active light control element can emit light from the light emitting layer in addition to the light incident on light control element 100, and thus can emit the amount of light greater than the amount of light incident on light control element 100. The active light control element can be used for lighting.

Light control element 100 according to the third example includes liquid crystal layer 3 that can be in the light reflection state and a light absorbing layer that functions as light control layer 12. More specifically, light control element 100 according to the third example includes the light absorbing layer and liquid crystal layer 3 containing a cholesteric liquid crystal.

Light control element 100 according to the fourth example includes liquid crystal layer 3 that can be in the light scattering state and a light absorbing layer that functions as light control layer 12. More specifically, light control element 100 according to the fourth example includes the light absorbing layer and liquid crystal layer 3 containing a polymer-dispersed liquid crystal. Alternatively, light control element 100 according to the fourth example includes the light absorbing layer and liquid crystal layer 3 containing a cholesteric liquid crystal.

Light control element 100 according to the fifth example includes liquid crystal layer (first liquid crystal layer) 3 that can be in the light scattering state and light control layer (second liquid crystal layer) 12 that can be in the light reflection state. Alternatively, light control element 100 according to the fifth example includes liquid crystal layer (first liquid crystal layer) 3 that can be in the light reflation state and light control layer (second liquid crystal layer) 12 that can be in the light scattering state. For example, light control element 100 according to the fifth example, one of liquid crystal layer 3 (first liquid crystal layer) and light control layer 12 (second liquid crystal layer) is a polymer-dispersed liquid crystal layer and the other one of liquid crystal layer 3 (first liquid crystal layer) and light control layer 12 (second liquid crystal layer) is a cholesteric liquid crystal layer. Moreover, in light control element 100 according to the fifth example, both liquid crystal layer 3 and light control layer 12 may be cholesteric liquid crystal layers. In this case, voltages may be applied to liquid crystal layer 3 and light control layer 12 so that liquid crystal layer 3 is brought into an optical state different from an optical state of light control layer 12. However, voltages may be applied to liquid crystal layer 3 and light control layer 12 so that liquid crystal layer 3 is always in the same optical state as light control layer 12. When liquid crystal layer 3 is in the reflection state and light control layer 12 is in the scattering state, light control element 100 functions as a blackout curtain. Furthermore, when both liquid crystal layer 3 and light control layer 12 are in the reflection state, the reflectivity of light control element 100 can be enhanced.

Note that since light control element 100 that does not include the light emitting layer as in the third to fifth examples, light control element 100 does not produce light on its own and thus can be called a passive light control element. In the passive light control element, by changing power supplied to light control layer 12 and liquid crystal 3, the state and/or amount of light emitted from first substrate 1 and/or second substrate 2 can be adjusted when receiving light externally.

As shown in FIG. 1, liquid crystal layer 3 may be larger than light control layer 12 in a plane orthogonal to the thickness direction of first substrate 1 and may cover light control layer 12. When liquid crystal layer 3 is larger than light control layer 12 and covers light control layer 12, liquid crystal layer 3 having the moisture-proof property can inhibit moisture from reaching light control layer 12 even when light control layer 12 is prone to deterioration from moisture. Thus, deterioration of light control element 100 can be further suppressed. In Embodiment 1, liquid crystal layer 3 is interposed between light control layer 12 and adhesive portion 5. With the interposition of liquid crystal layer 3 between light control layer 12 and adhesive portion 5, moisture passing through adhesive portion 5 can be inhibited from reaching light control layer 12 even when light control layer 12 is prone to deterioration from moisture. Here, the extension portions of first electrode 11 and second electrode 13 are exposed from liquid crystal layer 3 at the end portion of first substrate 1 outside the region enclosed by adhesive portion 5. However, note that the extension portions of first electrode 11 and second electrode 13 may be covered by liquid crystal layer 3 inside the aforementioned region. More specifically, liquid crystal layer 3 may cover the following: a portion that is not covered by light control layer 12, out of the extension portion of first electrode 11; and a portion that is not overlaid with light control layer 12, out of the extension portion of second electrode 13.

In Embodiment 1, liquid crystal layer 3 contains a moisture absorbing material having a moisture absorbing property. Examples of the moisture absorbing material include silica gel, calcium oxide, and titanium oxide. With the moisture absorbing material contained in liquid crystal layer 3, moisture that is to pass through liquid crystal layer 3 without the moisture absorbing material can be absorbed by the moisture absorbing material contained in liquid crystal layer 3. Thus, light control layer 12 can be inhibited from deteriorating from moisture. Hence, the life span of light control element 100 can be increased.

Moreover, light control element 100 according to Embodiment 1 further includes insulating layer 7 that has an electrical insulation property. Insulating layer 7 is disposed between first electrode 11 and second electrode 13 and also between light control layer 12 and liquid crystal layer 3. With light control element 100 including insulating layer 7, a short circuit between first electrode 11 and second electrode 13 can be suppressed. Thus, the electrical reliability of light control element 100 can be increased. Moreover, with physical separation between light control layer 12 and liquid crystal layer 3 via insulating layer 7, mutual influence of light control layer 12 and liquid crystal layer 3 on each other can be suppressed.

In Embodiment 1, insulating layer 7 wholly covers a portion (an extension portion) included in first electrode 11 and exposed from light control layer 12 in the region enclosed by adhesive portion 5 above first substrate 1. Moreover, insulating layer 7 is in contact with adhesive portion 5. Liquid crystal layer 3 is not interposed between adhesive portion 5 and insulating layer 7 (light control layer 12). More specifically, the extension portion of first electrode 11 is covered by adhesive portion 5 and insulating layer 7, and thus is not exposed from adhesive portion 5 and insulating layer 7. With this, liquid crystal layer 3 is less prone to influence from first electrode 11 (the extension portion of first electrode 11). In this case, light control laminate 10 is sealed by liquid crystal layer 3, first substrate 1, and insulating layer 7. Insulating layer 7 may have a moisture-proof property. With this, entry of moisture via insulating layer 7 can be suppressed.

Alternatively, insulating layer 7 may partially cover the extension portion of first electrode 11 in the region enclosed by adhesive portion 5 above first substrate 1. Here, insulating layer 7 may not be in contact with adhesive portion 5. In this case, liquid crystal layer 3 is interposed between adhesive portion 5 and insulating layer 7 (light control layer 12). With this, since liquid crystal layer 3, in addition to light control layer 12, seals insulating layer 7, moisture can be inhibited from reaching light control layer 12 even when insulating layer 7 is formed with a material that allows moisture easily pass through insulating layer 7. Insulating layer 7 may be formed with a material having an electrical insulation property, and can be formed with, for example, a resin having an electrical insulation property.

Here, an example of a method of manufacturing light control element 100 according to Embodiment 1 is described. It should be noted that the method of manufacturing light control element 100 according to Embodiment 1 is not limited to this example.

Firstly, first substrate 1 and second substrate 2 are prepared. On second substrate 2, third electrode 21 is formed. On first substrate 1, first electrode 11, light control layer 12, and second electrode 13 are formed in this order according to appropriate methods, such as sputtering, vapor deposition, and coating, to form light control laminate 10.

Next, insulating layer 7 is formed according to an appropriate method, such as sputtering, vapor deposition, or coating. Moreover, after the formation of a film that is to be a base of insulating layer 7, patterning may be performed by, for example, photolithography. Here, first electrode 11 may be formed on first substrate 1, then insulating layer 7 may be next formed on the first electrode 11, and then light control layer 12 may be formed on first electrode 11 and first substrate 1. After this, second electrode 13 may be formed on insulating layer 7, light control layer 12, and first substrate 1.

Next, first substrate 1 is coated with a resin that is a material of adhesive portion 5, in the shape of a frame surrounding light control laminate 10. A material of liquid crystal layer 3 is then poured into this frame formed with the resin.

Next, second substrate 2 is laid over first substrate 1 so that third electrode 21 is disposed in opposite to light control laminate 10. Then, the resin is cured to form adhesive portion 5, which thus bonds first substrate 1 and second substrate 2.

Here, assume that liquid crystal layer 3 is, for example, a polymer-dispersed liquid crystal layer and a material of liquid crystal 3 contains a polymerizable compound forming a high polymer. In this case, the resin may be cured and, at the same time, the high polymer of liquid crystal layer 3 may be formed by polymerizing the polymerizable compound so as to form liquid crystal layer 3. Moreover, assume that the resin material of adhesive portion 5 is compatible with the material of liquid crystal layer 3. In this case, a frame surrounding light control laminate 10 may be firstly formed on first substrate 1, and the material of liquid crystal layer 3 may be poured into the frame. Then, by bonding the frame and second substrate 2 with an adhesive member, first substrate 1 and second substrate 2 may be bonded. Adhesive portion 5 in this case is formed with the frame and the adhesive member stacked in the thickness direction of first substrate 1. Furthermore, the frame may be formed so as to surround light control laminate 10 on second substrate 2, and the material of liquid crystal layer 3 may be poured into the frame formed on second substrate 2. Then, by bonding this frame and first substrate 1 with an adhesive member, first substrate 1 and second substrate 2 may be bonded. Moreover, light control laminate 10 formed on first substrate 1 may be coated with the material of liquid crystal layer 3 to form liquid crystal layer 3. In this case, first substrate 1 and second substrate 2 are bonded so that liquid crystal layer 3 is in contact with third electrode 21. Furthermore, when liquid crystal layer 3 is, for example, a polymer-dispersed liquid crystal layer and does not drain from between first electrode 11 and third electrode 21 even without adhesive portion 5, adhesive portion 5 may be omitted.

As described thus far, in light control element 100 according to Embodiment 1, light control laminate 10 (light control layer 12) is sealed by liquid crystal layer 3 and first substrate 1. With this, moisture is inhibited from reaching light control layer 12, and deterioration of light control layer 12 can be suppressed even when liquid crystal layer 12 is prone to deterioration from moisture. Hence, the light control element that is less prone to deterioration and has a long life span and excellent reliability can be obtained.

Moreover, light control element 100 according to Embodiment 1 includes the following: liquid crystal layer 3 that changes in the optical state according to the applied voltage; and light control layer 12 formed to change in the optical state (the state of light emission, light scattering, light reflection, or light absorption) according to the supplied power (voltage or current). With this, the state and/or amount of light emitted from light control element 100 can be controlled finely. Furthermore, as compared with a device in which an element having liquid crystal layer 3 and an element having light control layer 12 are laminated, light control element 100 according to Embodiment 1 can commonditize the substrates and electrodes and, therefore, the number of members can be reduced. As a result, a less number of members that may possibly absorb light is required, and thus light control element 100 having a high transparency and excellent optical characteristics can be obtained.

To summarize the above explanation, in light control element 100 according to Embodiment 1, liquid crystal layer 3 that changes in the optical state according to the supplied power seals light control laminate 10. Thus, the light control element that has excellent optical characteristics and a long life span can be obtained.

FIG. 2 is a cross-sectional view showing a first variation of light control element 100 according to Embodiment 1. Light control element 100 according to the first variation includes moisture absorbing layer 9 that has a moisture absorbing property and is disposed along the outer periphery of liquid crystal layer 3 between first substrate 1 and second substrate 2. In this way, light control element 100 may include moisture absorbing layer 9 disposed along the outer periphery of liquid crystal layer 3. Moisture absorbing layer 9 contains a moisture absorbing agent having a moisture absorbing property. The moisture absorbing agent may be silica gel, calcium oxide, or titanium oxide. In the first variation, moisture absorbing layer 9 is formed in the shape of a frame surrounding light control layer 12 along the outer periphery of liquid crystal layer 3. However, moisture absorbing layer 9 may not be formed in the shape of a frame. Moisture absorbing layer 9 may be partially formed along the outer periphery of liquid crystal layer 3. In the first variation, the disposition of moisture absorbing layer 9 along the outer periphery of liquid crystal layer 3 allows moisture to be absorbed by moisture absorbing layer 9, and deterioration of light control layer 12 from moisture can be further suppressed. Hence, the life span of light control element 100 can be increased. Note that, in the first variation, moisture absorbing layer 9 is disposed between liquid crystal layer 3 and adhesive portion 5. In the first variation, since moisture absorbing layer 9 is in contact with first electrode 11 and third electrode 21, it is preferable for moisture absorbing layer 9 to have an electrical insulation property if only to suppress a short circuit. Moisture absorbing layer 9 may include a spacer.

In FIG. 2, the extension portion of first electrode 11 penetrates adhesive portion 5 and moisture absorbing layer 9 and is exposed at the end portion of first substrate 1. The extension portion of first electrode 11 functions as a terminal of light control layer 12. Similarly, second electrode 13 has the extension portion, which penetrates adhesive portion 5 and moisture absorbing layer 9 and is exposed at the end portion of first substrate 1. This extension portion functions not only as a terminal of light control layer 12 but also as a terminal for applying a voltage to liquid crystal layer 3. Note that insulating layer 7 is also provided in the first variation. Insulating layer 7 wholly covers the extension portion of first electrode 11 in a region enclosed by moisture absorbing layer 9. Moreover, insulating layer 7 penetrates moisture absorbing layer 9 and is in contact with adhesive portion 5. That is, the extension portion of first substrate 1 is covered by insulating layer 7 and adhesive portion 5 and thus is not exposed from insulating layer 7 and adhesive portion 5. However, insulating layer 7 may partially cover the extension portion of first electrode 11 in the region enclosed by moisture absorbing layer 9.

FIG. 3 is a cross-sectional view showing a second variation of light control element 100 according to Embodiment 1. As shown in FIG. 3, light control element 100 according to the second variation further includes the following: electrode 31 disposed on second substrate 2 on the opposite side of third electrode 21; third substrate 6 disposed opposite to second substrate 2; electrode 41 formed on a surface that is included in third substrate 6 and opposite to second substrate 2; and light control layer 4 disposed between electrode 31 and electrode 41. More specifically, light control element 100 according to the second variation further includes a pair of electrodes 31 and 41 and light control layer 4 sandwiched between the pair of electrodes 31 and 41 on second substrate 2. The light control element according to the second variation includes adhesive portion 8 that bonds second substrate 2 and third substrate 6 together. However, adhesive portion 8 may be omitted. Adhesive portion 8 can be formed with the same material used for forming adhesive portion 5.

Third substrate 6 is disposed on the opposite side of second substrate 2 and first substrate 1, at a spacing from second substrate 2. Third substrate 6 has transparency to visible light. As is the case with first substrate 1 and second substrate 2, third substrate 6 can be formed with glass or resin.

Each of electrode 31 and electrode 41 has electrical conductivity and transparency to visible light. Each of electrode 31 and electrode 41 can be formed with a material described above as an example of the material for first electrode 11 and second electrode 13. Electrode 31 may be formed wholly on a surface opposite to the surface of second substrate 2 on which third electrode 21 is formed (that is, a surface opposite to third substrate 6). Moreover, electrode 41 may be formed wholly on the surface that is included in third substrate 6 and opposite to second substrate 2.

Light control layer 4 is formed to change in the optical state according to power supplied using electrode 31 and electrode 41. When the optical state of light control layer 4 changes, the state of light emitted from the surface changes according to the power supplied to light control layer 4. Light control layer 4 may be a liquid crystal layer containing, for example, a nematic liquid crystal, a cholesteric liquid crystal, or a ferroelectric liquid crystal. Light control layer 4 may be a polymer-dispersed liquid crystal layer. More specifically, light control layer 4 may be formed to change between the transparent state and the light scattering state according to the supplied power (voltage). Alternatively, light control layer 4 may be a cholesteric liquid crystal layer. More specifically, light control layer 4 may be formed to change among the transparent state, the light scattering state, and the light reflection state according to the supplied power (voltage). Alternatively, light control layer 4 may be a light absorbing layer or a light emitting layer. To summarize the above explanation, light control layer 4 may be one of a liquid crystal layer, a light absorbing layer, and a light emitting layer. The liquid crystal layer may be a polymer-dispersed liquid crystal layer or a cholesteric liquid crystal layer. With the disposition of light control layer 4, higher functionality of light control element 100 can be achieved. For example, by allowing light control layer 4, light control layer 12, and liquid crystal layer 3 to have a light emission property, a light absorbing property, and a light scattering property, respectively, the three optical states can be freely controlled.

Light control element 100 according to the second variation may include adhesive portion 8 that bonds second substrate 2 and third substrate 6 together. Adhesive portion 8 is in the shape of a frame surrounding light control layer 4. Adhesive portion 8 functions as a spacer maintaining a distance between second substrate 2 and third substrate 6 so that light control layer 4 is interposed between electrode 31 and electrode 41. As with adhesive portion 5, adhesive portion 8 can be formed with a resin having an adhesive property, such as a thermosetting resin or an ultraviolet curable resin. Moreover, adhesive portion 8 may contain a spacer material, such as particles. Adhesive portion 8 may or may not have transparency to visible light.

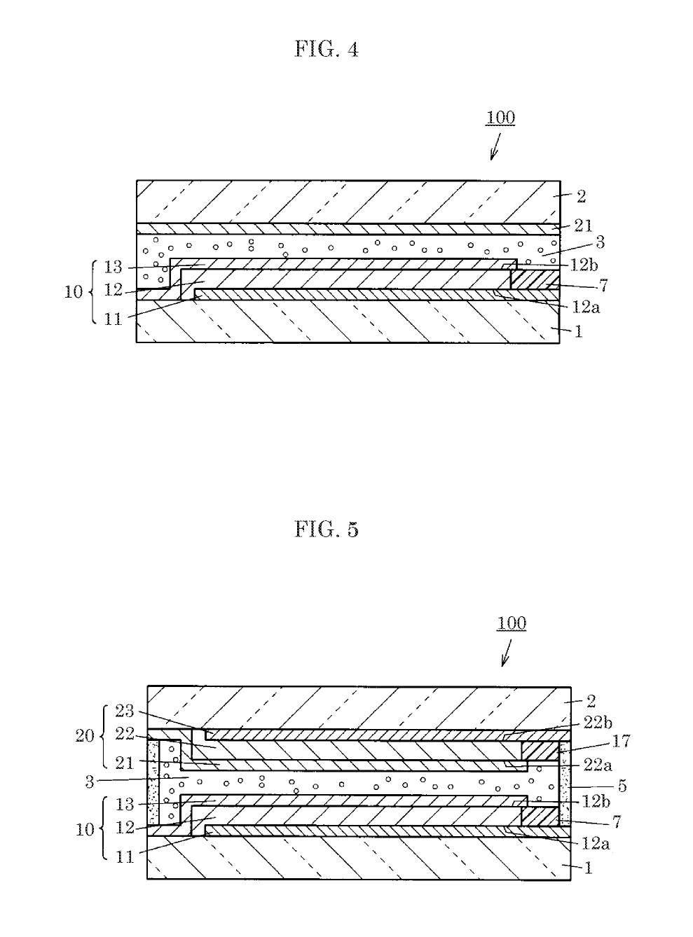

FIG. 4 is a cross-sectional view showing a third variation of light control element 100 according to Embodiment 1. As shown in FIG. 4, light control element 100 according to the third variation does not include adhesive portion 5. Moreover, light control layer 12 (light control laminate 10) is sealed by liquid crystal layer 3, insulating layer 7, and first substrate 1. Insulating layer 7 wholly covers the extension portion of first electrode 11, that is, a portion included in first electrode 11 and exposed from light control layer 12. More specifically, the extension portion of first electrode 11 is not exposed from insulating layer 7. In other words, first electrode 11 is covered by light control layer 12 and insulating layer 7, and is not exposed from light control layer 12 and insulating layer 7. Since light control element 100 according to the third variation does not include adhesive portion 5, light absorption and reflection by adhesive portion 5, for example, can be suppressed. As a result, light control element 100 that has more excellent optical characteristics can be obtained. Furthermore, since an area of a non-light-control portion is reduced, the design quality can be enhanced.

FIG. 5 is a cross-sectional view showing light control element 100 according to Embodiment 2. As shown in FIG. 5, as with light control element 100 according to Embodiment 1, light control element 100 according to Embodiment 2 includes first substrate 1, light control laminate 10 (hereinafter, also referred to as the first light control laminate) formed on first substrate 1, and second substrate 2 disposed opposite to first substrate 1. Light control laminate 10 includes first electrode 11 disposed on first substrate 1, second electrode 13 disposed opposite to first electrode 11, and light control layer (hereinafter, also referred to as first light control layer) 12 disposed between first electrode 11 and second electrode 13. Light control element 100 according to Embodiment 2 includes the following: third electrode 21 that is formed on second substrate 2 to be opposite to second electrode 13; and liquid crystal layer 3 that is disposed between second electrode 13 and third electrode 21 and seals light control laminate 10.

Light control element 100 according to Embodiment 2 is different from light control element 100 according to Embodiment 1 in that light control element 100 according to Embodiment 2 further includes light control layer (hereinafter, also referred to as second light control layer) 22 and fourth electrode 23 between third electrode 21 and second substrate 2. Light control element 100 according to Embodiment 2 is described below in more detail. It should be noted that the same reference signs are given to portions that are the same as in Embodiment 1 and that their explanation is omitted.

Light control element 100 according to Embodiment 2 includes fourth electrode 23 and second light control layer 22 between third electrode 21 and second substrate 2. Second light control layer 22 is disposed between third electrode 21 and fourth electrode 23. In light control element 100 according to Embodiment 2, third electrode 21, second light control layer 22, and fourth electrode 23 form light control laminate (hereinafter, also referred to as second light control laminate) 20. Second light control laminate 20 is a laminate of third electrode 21, second light control layer 22, and fourth electrode 23. Fourth electrode 23, second light control layer 22, and third electrode 21 are arranged along the thickness direction of second substrate 2 (the same direction as the thickness direction of first substrate 1, that is, the vertical direction in FIG. 5), in this order from a side closer to second substrate 2. Second light control laminate 20 is formed on second substrate 2 and disposed between first substrate 1 and second substrate 2. First light control laminate 10 is sealed by liquid crystal layer 3 and first substrate 1, and second light control laminate 20 is sealed by liquid crystal layer 3 and second substrate 2.

Fourth electrode 23 has electrical conductivity. Moreover, fourth electrode 23 has transparency to visible light. Fourth electrode 23 can be formed with transparent metal oxide (such as ITO or IZO) or resin containing conducting particles. Moreover, fourth electrode 23 may be a thin film formed with silver, or may be a laminate of transparent metal oxide and metal. As shown in FIG. 5, fourth electrode 23 and third electrode 21 are not in contact with each other and separated by second light control layer 22.

Fourth electrode 23 has an extension portion that extends from second light control laminate 20 toward an end portion of second substrate 2. The extension portion of fourth electrode 23 penetrates adhesive portion 5 and is exposed at the end portion of second substrate 2. The extension portion of fourth electrode 23 is a portion that is not overlaid with second light control layer 22 (or, not covered by second light control layer 22) out of fourth electrode 23. The extension portion of fourth electrode 23 functions as a terminal for applying a voltage to second light control layer 22. Note that, unlike third electrode 21 according to Embodiment 1, third electrode 21 according to Embodiment 2 is not formed on the whole surface of second substrate 2. As with fourth electrode 23, third electrode 21 has an extension portion that extends from second light control laminate 20 toward the end portion of second substrate 2. The extension portion of third electrode 21 is a portion that is not covered by second light control layer 22, out of third electrode 21. The extension portion of third electrode 21 functions as a terminal for applying a voltage from an external power source to second light control layer 22. The extension portion of third electrode 21 also functions as a terminal for applying a voltage from the external power source to liquid crystal layer 3.

Second light control layer 22 is disposed between third electrode 21 and fourth electrode 23. Second light control layer 22 is formed to change in the optical state of second light control layer 22 according to power supplied to second light control layer 22 using third electrode 21 and fourth electrode 23. When the optical state of second light control layer 22 changes according to the supplied power, this means that the state of light emitted from the surface of second light control layer 22 is adjusted. Alternatively, when the optical state of second light control layer 22 changes according to the supplied power, this means that the amount of light emitted from the surface of second light control layer 22 is adjusted.

For example, second light control layer 22 may be formed to change in the optical state according to the supplied power. When second light control layer 22 that changes in the optical state according to the supplied power receives light, the state and/or amount of light emitted from the surface of second light control layer 22 according to the supplied power is adjusted. For example, assume that second light control layer 22 (light control element 100) receives light that travels in the direction from first substrate 1 toward second substrate 2. In this case, the state and/or amount of light passing through second light control layer 22 and emitted from surface 22b included in second light control layer 22 and opposite to second substrate 2 is adjusted. Moreover, assume that second light control layer 22 (light control element 100) receives light that travels in the direction from second substrate 2 toward first substrate 1. In this case, the state and/or amount of light passing through second light control layer 22 and emitted from surface 22a that is included in second light control layer 22 and opposite to first substrate 1 is adjusted. It should be noted that second light control layer 22 can receive both the light traveling in the direction from first substrate 1 toward second substrate 2 and the light traveling in the direction from second substrate 2 toward first substrate 1.

Second light control layer 22 may include, for example, a liquid crystal and may be a liquid crystal layer (hereinafter, also referred to as a third liquid crystal layer) formed to change in the orientation (orientation state) of the liquid crystal of light control layer 12 according to the applied voltage. The third liquid crystal layer can be formed with, for example, a nematic liquid crystal, a cholesteric liquid crystal, or a ferroelectric liquid crystal. The third liquid crystal layer may be formed to change between the transparent state and the light scattering state. More specifically, liquid crystal layer 3 may contain a polymer-dispersed liquid crystal. Alternatively, the third liquid crystal layer may be formed to change among the transparent state, the light scattering state, and the light reflection state. More specifically, liquid crystal layer 3 may contain a cholesteric liquid crystal.

Second light control layer 22 may be formed to change in light absorption according to the supplied power (current). More specifically, second light control layer 22 may be a light absorbing layer. Alternatively, second light control layer 22 may be formed to emit light according to the supplied power (current). More specifically, second light control layer 22 may be a light emitting layer.

To summarize the above explanation, second light control layer 22 may be one of the third liquid crystal layer, the light absorbing layer, and the light emitting layer. The third liquid crystal layer may be a polymer-dispersed liquid crystal layer or a cholesteric liquid crystal layer.

Note that, in Embodiment 2, in addition to first substrate 1, second substrate 2, first electrode 11, second electrode 13, and third electrode 21, fourth electrode 23 has transparency to visible light. On this account, when first light control layer 12, liquid crystal layer 3, and second light control layer 22 are in the transparent state, light control element 100 allows light to pass through it.

Furthermore, as in the second variation of Embodiment 1, a pair of electrodes and a light control layer sandwiched between the pair of electrodes may also be formed on second substrate 2 on the opposite side of third electrode 21 in Embodiment 2.

To summarize the above explanation, examples of light control element 100 according to Embodiment 2 include light control elements according to sixth to tenth examples described below.

Light control element 100 according to the sixth example includes a layer that can be in the light scattering state, a light emitting layer, and a layer that can be in the light reflection state. For example, liquid crystal layer 3 is the layer that can be in the light scattering state, that is, a polymer-dispersed liquid crystal layer or a cholesteric liquid crystal layer. One of first light control layer 12 and second light control layer 22 is the light emitting layer, and the other one is the layer that can be in the light reflection state, that is, the cholesteric liquid crystal layer. Although both liquid crystal layer 3 and the other one of first light control layer 12 and second light control layer 22 may be cholesteric liquid crystal layers, it is preferable for liquid crystal layer 3 to be the polymer-dispersed liquid crystal layer. In other words, light control element 100 according to the sixth example may include the polymer-dispersed liquid crystal layer, the light emitting layer, and the cholesteric liquid crystal layer. With this, light control element 100 according to the sixth example can cause light emitted from the light emitting layer (one of first light control layer 12 and second light control layer 22) to be dispersed by liquid crystal layer 3 and reflected by the other one of first light control layer 12 and second light control layer 22. In this way, the light from the light emitting layer can be extracted efficiently.

Light control element 100 according to the seventh example includes a light emitting layer, a layer that can be in the light reflection state, and a light absorbing layer. For example, liquid crystal layer 3 is the layer that can be in the light reflection state, that is, a cholesteric liquid crystal layer. One of first light control layer 12 and second light control layer 22 is the light emitting layer, and the other one is the light absorbing layer. More specifically, light control element 100 according to the seventh example includes the light emitting layer, the cholesteric liquid crystal layer, and the light absorbing layer.

Light control element 100 according to the eighth example includes a layer that can be in the light scattering state, a light emitting layer, and a light absorbing layer. For example, liquid crystal layer 3 is the layer that can be in the light scattering state, that is, a polymer-dispersed liquid crystal layer or a cholesteric liquid crystal layer. One of first light control layer 12 and second light control layer 22 is the light emitting layer, and the other one is the light absorbing layer. More specifically, light control element 100 according to the eighth example includes the polymer-dispersed liquid crystal layer, the light emitting layer, and the light absorbing layer. Alternatively, light control element 100 according to the eighth example includes the cholesteric liquid crystal layer, the light emitting layer, and the light absorbing layer.

Light control element 100 according to the ninth example includes a layer that can be in the light scattering state, a layer that can be in the light reflection state, and a light absorbing layer. For example, one of liquid crystal layer 3, first light control layer 12, and second light control layer 22 is the polymer-dispersed liquid crystal, and another is the light absorbing layer, and the other is the cholesteric liquid crystal layer.

Light control element 100 according to the tenth example includes a layer that can be in the light scattering state, a light emitting layer, a layer that can be in the light reflection state, and a light absorbing layer. As in the second variation of Embodiment 1, light control element 100 according to the tenth example includes a pair of electrodes and a light control layer sandwiched between the pair of electrodes which are formed on second substrate 2 on the opposite side of third electrode 21. For example, the light control layer is formed on second substrate 2 of light control element 100 according to the eighth example on the opposite side of third electrode 21. This light control layer is a cholesteric layer that can be in the light reflection state. More specifically, light control element 100 according to the tenth example includes the polymer-dispersed liquid crystal layer, the light emitting layer, the cholesteric layer, and the light absorbing layer.

Light control elements 100 according to the sixth to eight and tenth examples include the light emitting layers, and thus are classified as the active light control elements, as with the first and second examples. On the other hand, light control element 100 according to the ninth example does not include a light emitting layer, and thus is classified as the passive light control element, as with the third to fifth examples.

Liquid crystal layer 3 may be larger than first light control layer 12 in a plane orthogonal to the thickness direction of first substrate 1 and may cover first light control layer 12. Moreover, in Embodiment 2, liquid crystal layer 3 may be larger than second light control layer 22 in the plane orthogonal to the thickness direction and may cover second light control layer 22. Furthermore, liquid crystal layer 3 may contain a moisture absorbing material having a moisture absorbing property. Moreover, as in the first variation of Embodiment 1, light control element 100 according to Embodiment 2 may include liquid crystal layer 3 that has a moisture absorbing property and moisture absorbing layer 9 that is disposed along the outer periphery of liquid crystal layer 3 between first substrate 1 and second substrate 2.

Light control element 100 according to Embodiment 2 includes adhesive portion 5 that bonds first substrate 1 and second substrate 2 together In Embodiment 2, adhesive portion 5 surrounds not only first light control laminate 10 but also second light control laminate 20. However, light control element 100 according to Embodiment 2 may not include adhesive portion 5.

As with light control element 100 according to Embodiment 1, light control element 100 according to Embodiment 2 includes insulating layer 7 (hereinafter, also referred to as a first insulating layer) that is disposed between first electrode 11 and second electrode 13 and also between first light control layer 12 and liquid crystal layer 3. Light control element 100 according to Embodiment 2 further includes insulating layer 17 (hereinafter, also referred to as a second insulating layer) that has an electrical insulation property. Second insulating layer 17 is disposed between third electrode 21 and fourth electrode 23 and also between second light control layer 22 and liquid crystal layer 3.

With light control element 100 including second insulating layer 17, a short circuit between third electrode 21 and fourth electrode 23 can be suppressed. Thus, the electrical reliability of light control element 100 can be increased. Moreover, with physical separation between second light control layer 22 and liquid crystal layer 3 via second insulating layer 17, mutual influence of second light control layer 22 and liquid crystal layer 3 on each other can be suppressed.

In Embodiment 2, second insulating layer 17 wholly covers a portion (an extension portion) included in fourth electrode 23 and exposed from second light control layer 22 in the region enclosed by adhesive portion 5. Moreover, second insulating layer 17 is in contact with adhesive portion 5. More specifically, second insulating layer 17 is not exposed from the extension portion of fourth electrode 23 in the region enclosed by adhesive portion 5. With this, liquid crystal layer 3 can be less prone to influence from fourth electrode 23 (the extension portion of fourth electrode 23). Here, liquid crystal layer 3 can be said to seal second light control laminate 20 together with second substrate 2 and second insulating layer 17. In this case, second insulating layer 17 may have a moisture-proof property so that entry of moisture via adhesive portion 5 and second insulating layer 17 can be suppressed. Moreover, second insulating layer 17 may partially cover the extension portion of fourth electrode 23 in the region enclosed by adhesive portion 5. Here, second insulating layer 17 may not be in contact with adhesive portion 5. In this case, liquid crystal layer 3 is interposed between adhesive portion 5 and second insulating layer 17 (second light control layer 22). With this, since liquid crystal layer 3, in addition to second light control layer 22, seals second insulating layer 17, moisture can be inhibited from reaching second light control layer 22 even when insulating layer 17 is formed with a material that allows moisture easily pass through insulating layer 17. Second insulating layer 17 may be formed with a material having an electrical insulation property, and can be formed with, for example, a resin having an electrical insulation property.

As described thus far, in light control element 100 according to Embodiment 2, first light control laminate 10 (first light control layer 12) is sealed by liquid crystal layer 3 and first substrate 1, and second light control laminate 20 (second light control layer 22) is sealed by liquid crystal layer 3 and second substrate 2. With this, liquid crystal layer 3 inhibits moisture from reaching a plurality of light control layers (first light control layer 12 and second light control layer 22). Thus, deterioration of first light control layer 12 and second light control layer 22 can be suppressed even when first liquid crystal layer 12 and second light control layer 22 are prone to deterioration from moisture. Hence, the light control element that is less prone to deterioration and has a long life span and excellent reliability can be obtained. Moreover, light control element 100 according to Embodiment 2 includes the following: liquid crystal layer 3 that changes in the optical state according to the applied voltage; and the plurality of light control layers (first light control layer 12 and second light control layer 22) that change in the optical state (the state of light emission, light scattering, light reflection, or light absorption) according to the supplied power (voltage or current). With this, the state and/or amount of light emitted from light control element 100 can be controlled finely. Furthermore, as compared with a device in which an element having liquid crystal layer 3 and an element having a light control layer are laminated, light control element 100 according to Embodiment 2 can commonditize the substrates and electrodes and, therefore, the number of members can be reduced. As a result, a less number of members that may possibly absorb light is required, and thus light control element 100 having a high transparency and excellent optical characteristics can be obtained. To summarize the above explanation, in light control element 100 according to Embodiment 2, liquid crystal layer 3 that changes in the optical state according to the applied voltage seals the plurality of light control laminates (first light control laminate 10 and second light control laminate 20). Thus, deterioration of light control layer 12 can be suppressed, and also the light control element requiring a less number of members and having a high transparency can be obtained. In other words, the light control element that has excellent optical characteristics and a long life span can be obtained.

Here, an example of a method of manufacturing light control element 100 according to Embodiment 2 is described. It should be noted that the method of manufacturing light control element 100 according to Embodiment 2 is not limited to this example.

Firstly, first substrate 1 and second substrate 2 are prepared. On first substrate 1, first electrode 11, light control layer 12, and second electrode 13 are formed in this order according to appropriate methods, such as sputtering, vapor deposition, and coating, to form first light control laminate 10. On second substrate 2, fourth electrode 23, second light control layer 22, and third electrode 21 are formed in this order according to appropriate methods, such as sputtering, vapor deposition, and coating, to form second light control laminate 20.

Next, first insulating layer 7 is formed on first electrode 11, and second insulating layer 17 is formed on fourth electrode 23. The insulating layers (first insulating layer 7 and second insulating layer 17) may be formed according to appropriate methods, such as sputtering, vapor deposition, and coating. Alternatively, after the formation of a film that is to be a base of the insulating layer, patterning may be performed by, for example, photolithography. Here, first electrode 11 may be formed on first substrate 1, then first insulating layer 7 may be next formed on first electrode 11, and then first light control layer 12 may be formed on first electrode 11 and first substrate 1. After this, second electrode 13 may be formed on first insulating layer 7, first light control layer 12, and first substrate 1. Moreover, fourth electrode 23 may be formed on second substrate 2, and second insulating layer 17 and second light control layer 22 may be next formed. Then, third electrode 21 may be formed on second insulating layer 17, second light control layer 22, and second substrate 2.

After this, first substrate 1 or second substrate 2 may be coated with a resin that is a material of adhesive portion 5, in the shape of a frame. Then, liquid crystal layer 3 is then poured into this frame formed with the resin. Next, first substrate 2 and second substrate 2 are joined so that second electrode 13 and third electrode 21 are opposed to each other and separated by liquid crystal layer 3. Then, a resin is cured to form adhesive portion 5, which then bonds first substrate 1 and second substrate 2 together. In this way, light control element 100 according to Embodiment 2 can be formed.

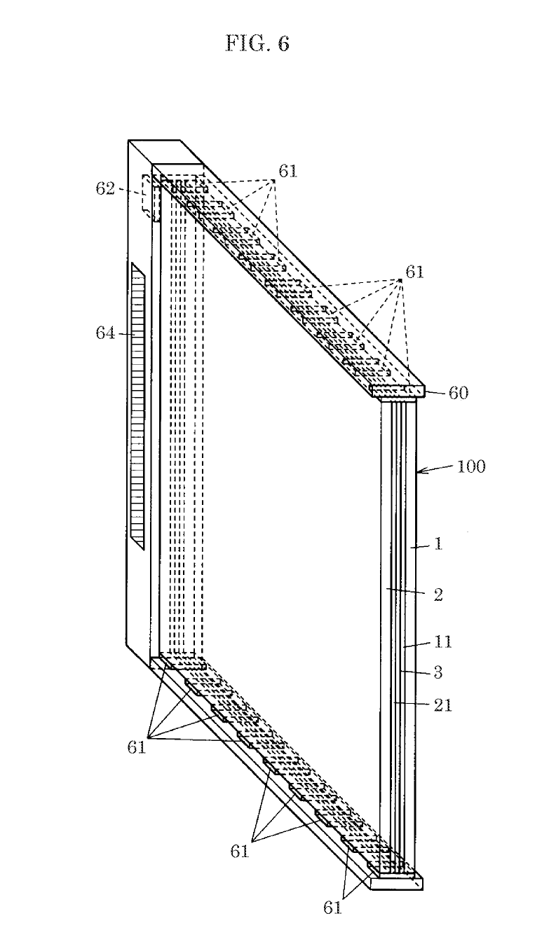

FIG. 6 is a perspective view showing an example of a building material including light control element 100. In FIG. 6, a window is shown as the building material including light control element 100. The building material includes frame 60 for fixing light control element 100 and light control element 100.

In the example shown in FIG. 6, frame 60 includes power feeder 61 for supplying power to light control element 100, storage battery 62 for driving light control element 100 with stability, and ventilating opening 64. However, frame 60 may not include power feeder 61, storage battery 62, and ventilating opening 64. The window including light control element 100 can be used for automobiles, electric trains, locomotives, railway trans, airplanes, and ships. Furthermore, the building material can be used as, for example, a wall material, a partition, and signage.

To summarize the above explanation, light control element 100 according to an aspect of the present invention has a first feature as follows. According to the first feature, light control element 100 includes first substrate 1, light control laminate 10, and second substrate 2 opposed to first substrate 1. Light control laminate 10 includes first electrode 11 disposed on first substrate 1, second electrode 13 disposed opposite to first electrode 11, and light control layer 12 disposed between first electrode 11 and second electrode 13. First electrode 11, second electrode 13, and light control layer 12 are arranged in the thickness direction of first substrate 1. Light control layer 12 is formed to change in the optical state according to power supplied using first electrode 11 and second electrode 13. Light control element 100 further includes the following: third electrode 21 formed on second substrate 2 to be opposed to second electrode 13; and liquid crystal layer 3 disposed between second electrode 13 and third electrode 21. Light control laminate 10 is sealed by liquid crystal layer 3 and first substrate 1.

Furthermore, in addition to the first feature, light control element 100 further arbitrarily has second to sixth features as follows.

According to the second feature, in light control element 100 having the first feature, liquid crystal layer 3 is larger than light control layer 12 in a plane orthogonal to the aforementioned thickness direction and covers light control layer 12.

According to the third feature, in light control element 100 having the first or second feature, liquid crystal layer 3 is formed to change between the transparent state and the light scattering state.

According to the fourth feature, in light control element 100 having the first or second feature, liquid crystal layer 3 is formed to change between the transparent state and the light reflection state.

According to the fifth feature, light control element 100 having one of the first to fourth features includes moisture absorbing layer 9 that has a moisture absorbing property and is disposed along the outer periphery of liquid crystal layer 3 between first substrate 1 and second substrate 2.

According to the sixth feature, in light control element 100 having one of the first to fifth features, liquid crystal layer 3 contains a moisture absorbing material having a moisture absorbing property.

Furthermore, according to an aspect of the present invention, a building material includes light control element 100 having one of the first to sixth features.

Although the light control element, the building material including the same, and so forth are described based on the embodiments, the light control element and so forth according to the present disclosure are not limited to the embodiments described above. For example, other embodiments implemented through various changes and modifications conceived by a person of ordinary skill in the art based on the above embodiments or through a combination of the structural components and functions in the above embodiments unless such combination departs from the scope of the present invention may be included in the scope in an aspect or aspects according to the present invention.

### REFERENCE MARKS IN THE DRAWINGS

1 first substrate
2 second substrate
3 liquid crystal layer
5 adhesive portion
7 insulating layer
9 moisture absorbing layer
10 light control laminate
11 first electrode
12 light control layer (first light control layer)
13 second electrode

1. A light control element comprising:
a first substrate;
a light control laminate including
a first electrode disposed on the first substrate,
a second electrode disposed opposite to the first electrode, and
a light control layer disposed between the first electrode and the second electrode and formed to change in an optical state according to power supplied using the first electrode and the second electrode,
the first electrode, the second electrode, and the light control layer being arranged in a thickness direction of the first substrate;
a second substrate disposed opposite to the first substrate;
a third electrode formed on the second substrate to be opposite to the second electrode; and
a liquid crystal layer disposed between the second electrode and the third electrode,
wherein the liquid crystal layer covers an upper surface and a side surface of the light control laminate.

2. The light control element according to claim 1,
wherein the liquid crystal layer is larger than the light control layer in a plane orthogonal to the thickness direction and covers the light control layer.

3. The light control element according to claim 1,
wherein the liquid crystal layer is formed to change between a transparent state and a light scattering state.

4. The light control element according to claim 1,
wherein the liquid crystal layer is formed to change between a transparent state and a light reflection state.

5. The light control element according to claim 1, comprising
a moisture absorbing layer that has a moisture absorbing property and is disposed along an outer periphery of the liquid crystal layer between the first substrate and the second substrate.

6. The light control element according to claim 1,
wherein the liquid crystal layer contains a moisture absorbing material having a moisture absorbing property.

7. A building material comprising the light control element according to claim 1.
